(19) United States
(12) Patent Application Publication
(10) Pub. No.: US 2024/0054280 A1
(43) Pub. Date: Feb. 15, 2024

(54) Segmenting an Unstructured Set of Data

(71) Applicant: Ivalua S.A.S., Massy Cedex (FR)

(72) Inventors: Christopher BOUREZ, Massy (FR); Pascal BENSOUSSAN, Massy (FR); Xuan Khanh DO, Massy (FR)

(21) Appl. No.: 17/818,636

(22) Filed: Aug. 9, 2022

(51) Int. Cl. G06F 40/151; G06V 30/148; G06V 30/19; G06F 40/103; G06F 16/35

(52) U.S. Cl. CPC G06F 40/151; G06V 30/148; G06V 30/19093; G06V 30/19173; G06F 40/103; G06F 16/353

(57) ABSTRACT

There is provided a computer implemented method of transforming an unstructured set of data to a structured set of data. In some examples, the method comprises segmenting the unstructured set of data into segments, classifying each segment, extracting key terms from each segment using an extraction model, the extraction model selected from a plurality of extraction models based on the classification of the segment, generating the structured set of data using the segments and the extracted key terms.

### BACKGROUND OF THE INVENTION

### Field of the Invention

The present application relates to document processing in which an unstructured set of data is processed into a structure set of data.

### Description of the Related Technology

The field of machine reading comprehension (MRC) allows for numerous applications, such as sourcing, trend analysis, conversational agents, sentiment analysis, document management, cross-language business development, and the like. The data analyzed for such applications include natural language, which is rarely in structured form. The data may include any form of human communication, such as live conversations (e.g., chatbots, emails, speech-to-text applications, audio recordings, etc.) in addition to documents and writings stored in databases.

With respect to contract and legal data, several technical problems arise in the field of MRC. While users of such data need to analyze the data to manage risk, apply risk policies, ensure accuracy of parameters, and the like, the vast amount of data makes this review impractical, complicated, and prone to errors. Attempts to address this problem include templates and standardized clauses, although the contract documents at issue typically include a large amount of wild texts that have been modified from templates through the removal or alteration of clauses, specific conditions, inputs from third parties during negotiation, and/or the like.

Using machine learning and artificial intelligence techniques with such data presents additional technical problems. For example, the wide variety of different formats and styles of contracts and legal data make it difficult for an algorithm to parse. Further the amount of available data across this wide area may be too limited to effectively train an algorithm. This is hampered because a large amount of legal data is not publicly available due to confidentiality requirements. Another technical problem is that legal language is much different than common, conversational language, and trained language algorithms based on typical language and writings may not be accurate for contract documents and other legal documents.

### SUMMARY

According to a first aspect, there is provided a computer-implemented method of transforming an unstructured set of data, such as a PDF image of a contract document, into a structured set of data, such as data and metadata describing the contract document in a database. The method comprises segmenting the unstructured set of data into segments by: identifying one or more data blocks from the unstructured set of data; determining one or more attributes associated with each data block; and applying the data blocks with respective attributes to a segmentation model to generate the segments. The method then logically groups the segments with similar segments, and generates the structured set of data using the classified and grouped segments.

In some embodiments, this allows the contract document or other previously unstructured set of data to be more easily navigated, understood and analyzed, for example by comparing this with a master contract document or other contract documents associated with a user.

In some embodiments, the one or more attributes are selected from: one or more style attributes associated with individual or groups of characters in the respective data block; one or more text attributes associated with the arrangement of the characters within the respective data block; one or more paragraph attributes associated with the arrangement of the respective data block within the set of unstructured data.

In some embodiments, identifying the one or more data blocks comprises: identifying sequences of characters in the unstructured set of data having a common characteristic; and combining one or more sequences of characters according to predetermined logic to identify each said data block.

In some embodiments, the similar segments are determined from a library of structured sets of data and based on an edit distance and/or an embedding distance between the segment and a segment in the library, or some other suitable similarity metric.

According to another aspect there is provided a computer-implemented method of transforming an unstructured set of data, such as a PDF image of a contract document, to a structured set of data, such as data and metadata describing the contract document in a database. The method comprises segmenting the unstructured set of data into segments, classifying each segment, and extracting key terms from each segment using an extraction model, the extraction model selected from a plurality of extraction models based on the classification of the segment. The method generating the structured set of data using the segments and the extracted key terms.

In some embodiments, this improves the accuracy of structuring the unstructured data set, including for example the key term extraction by selecting a model based on classification.

Corresponding systems and computer program products are also provided.

### BRIEF DESCRIPTION OF THE DRAWINGS

Various features of the present disclosure will be apparent from the detailed description which follows, taken in conjunction with the accompanying drawings, which together illustrate, features of the present disclosure, and wherein:

FIG. 1 is a schematic diagram of a system for processing documents, according to an example.

FIG. 2 is a schematic diagram of a part of the system of FIG. 1 for segmenting and classifying segments, according to an example.

FIG. 3 is a schematic diagram of a part of the system of FIG. 1 for grouping classified segments and generating structured data using navigation based on the classifications, according to an example.

FIG. 4 is a flowchart of a method of segmenting and classifying an unstructured document to generate structured data, according to an example.

FIG. 5 is a schematic diagram of a part of the system of FIG. 1 for extracting key terms, according to an example.

FIG. 6 is a flowchart of a method of extracting key terms, according to an example.

FIG. 7 illustrates data-structures according to an example.

FIG. 8 is a schematic diagram of an apparatus for segmenting, classifying, and extracting key terms from a document, according to an example; and

FIG. 9 is a schematic diagram of a distributed system for segmenting, classifying, and extracting key terms from a document, according to an example.

### DETAILED DESCRIPTION OF CERTAIN EMBODIMENTS

Examples address some of the limitations of automating the conversion of unstructured data, such as a contract document in any arbitrary format and layout, into structured data in which the data from the contract document is logically arranged and easily accessed using standard computing tools. This enables key information such as indemnification limits and termination dates to be easily identified, for example to highlight parts of the contract to review for certain purposes, such as risk assessment. Similarly, once the data is in a standardized form, different contracts can be compared to help identify weaknesses or other issues, to develop templates or to assist with updating a contract.

Some examples identify complete clauses or segments from an unstructured set of data such as a contract document and group these clauses or segments by classification to enable hierarchical navigation of the document. This allows a user or an automated system to navigate about the document to locate logically related clauses which may be in different parts of the document. Examples may be implemented using separately trained segmentation and classification machine learning models. Some examples may additionally or alternatively identify complete clauses or segments from an unstructured set of data such as a contract document, classify these clauses and extract key terms from the clauses dependent on their classification. Different clauses may be input to different separately trained key term extraction machine learning models. Different key term extraction models may be trained for respective classifications. The use of separately trained models for different functions improves the accuracy of the models' performance as their respective inputs will be more similar than if a single model was employed across the full range of potential unstructured data inputs.

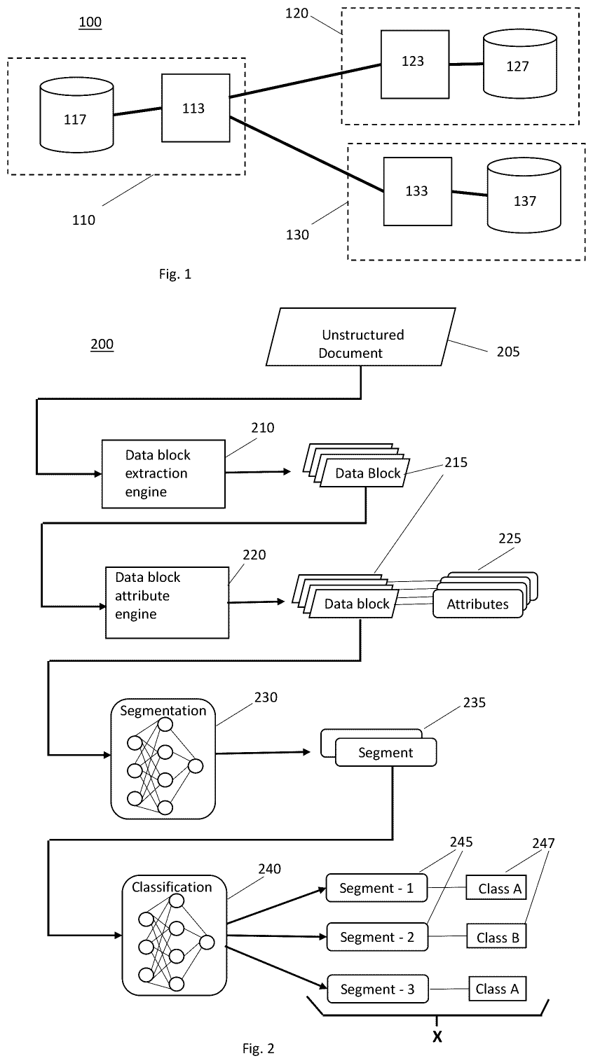

FIG. 1 a schematic diagram of a system 100 for processing documents, according to an example. The computing system 100 comprises a service provider 110 and a plurality of users 120, 130 communicatively coupled to the service provider 110. The service provider 110 may provide contract processing services to the users 120, 130 to enable transforming of an unstructured set of data, such as a PDF image of a contract document in an arbitrary format, into a structured set of data such as a datastructure having logically linked and arranged data and metadata representing text.

The service provider 110 comprises a server system 113 and a storage system 117. The server system 113 is communicatively coupled to the storage system 117 and is configured to execute methods that segment the unstructured data into segments such as clauses, and/or classify each segment, and/or group the segments having the same classification, and/or extract key terms from each segment based on the respective classification. Some or all of these functions may be achieved using multiple separately trained machine learning models or algorithms. The storage system 117 comprises primary storage (Random Access Memory (RAM)) and secondary storage (a hard disk or a solid-state storage device) and stores the machine learning models such as segmentation, classification and key term extraction models and may also store unstructured and structured sets of data, for example corresponding to contract documents.

Each user 120, 130 may comprise a server system 123 and a corresponding storage system 127, 137. The storage systems 127, 137 may store contract documents for each user 120, 130. And which may be stored in unstructured and/or structured formats. The respective server systems 123, 133 may provide a user interface for a user to access structured or unstructured data, and forward unstructured data to the service provider 110 to transform this into structured data for returning to the user 120, 130. The contract documents provided from different users, and suitably anonymized, may be used to further train the machine learning models in the service provider 110.

In an alternative arrangement, each user 120, 130 may independently transform their own unstructured data into structured data. The service provider 110 may provide initial trained models to each user for this purpose, each user then being able to further train their models using their own contract documents data.

FIG. 2 is a schematic diagram of a part of the system of FIG. 1 for segmenting and classifying segments, according to an example. The partial system 200 may be used by a user to perform segmentation and classification functions and comprises separately trained segmentation 230 and classification 240 models. The partial system 200 also comprises a paragraph extraction engine 210 and a paragraph attribute engine 220. These engines 210, 220 may be implemented using rules-based algorithms which may be coded, for example, in C++ and executed using a processor and memory.

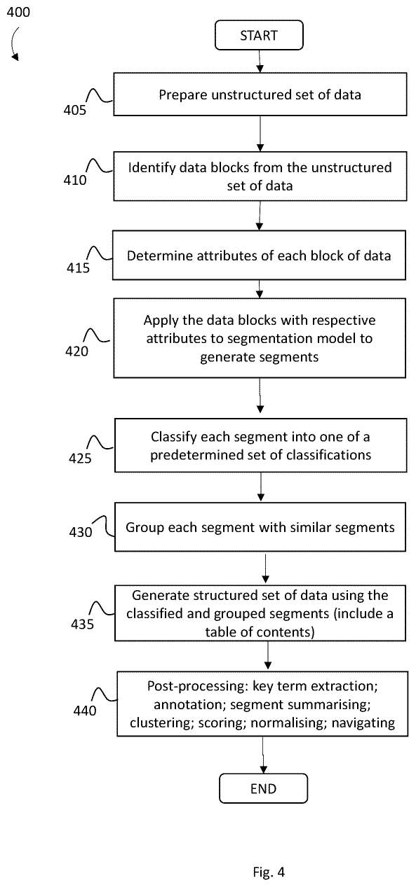

Reference is also made to FIG. 4 which is a flowchart of a method 400 of segmenting and classifying an unstructured document to generate structured data, according to an example. This may be implemented using the partial system of FIG. 2.

At 405, the method may prepare an unstructured set of data 205 such as a contract document in an arbitrary file format, layout and style. For example, the contract document 205 may be a PDF image received from a supplier of the user and originally generated according to a contract template of the supplier and which may be quite different to that normally used by the user. The font type and size may be different, different conventions may be used for italicizing characters, the layout of text across a page may also be different as well as any other attributes. If the unstructured set of data, for example the contract document, is a PDF image, it may first be prepared by OCR′ ing the image to generate individual characters in an electronic file format. The unstructured set of data may be converted into a common file format, such as Microsoft™ Word™. Some unstructured sets of data may not require initial preparation, for example because they are already in a wanted common file format.

At 410, the method identifies data blocks from the unstructured set of data. The data blocks 215 may be implemented by a rules-based data block extraction engine 210 using rules such as combining sequences or lines of text where the font does not change, and/or which may be bracketed by carriage return control elements as well as other language independent attributes. In an example, the blocks of data may correspond to paragraphs identified by a software engine such as Aspose.Word which is available from www.aspose.com. Aspose.Word identifies runs which are sequences of characters having the same formatting and combines these into paragraphs using embedded controls such as carriage return. Various other engines may alternatively be used for identifying data blocks and their attributes, for example OpenXML from www.microsoft.com can be used to extract styles from blocks of data. Other examples include RasterEdge (www.rasteredge.com) and Syncfusion (www.syncfusion.com).

At 415, the method determines attributes for each block of data such as an Aspose paragraph. This may be implemented using a rules-based language-independent data block attribute engine 220 using a wider range of attributes 225 than the data block extraction engine 210. The runs attribute information extracted by Aspose are used as inputs to calculate data block attributes and may include one or more of the following different types of attributes: style attributes associated with individual or groups of characters in a data block; text attributes associated with the arrangement of the respective data block within the set of unstructured data; paragraph attributes associated with the arrangement of the respective data blocks within the set of unstructured data. Examples of style attributes include font weight, underline, italics, font size, all words capitalized, style of first line and style of previous paragraph. Examples of text attributes include number of words, number of lines, enumeration. Examples of paragraph attributes include relative position in the x dimension, relative width of the paragraph (compared with page width), relative height of the paragraph, first run of paragraph has underlining, bold or italics.

At 420, the method applies the data blocks 215 with respective attributes 225 to a segmentation model 230 to generate segments 235 such as clauses. The segmentation model 230 may be trained to classify whether each data block such as an Aspose paragraph is the start of a segment such as a legal clause, based on the attributes of each data block. The data blocks which are not classified as being the start of a clause are then added to the preceding data block which has been classified as the start of a clause, in order to form a segment. The set of unstructured data such as a contract document can then be converted into a series of segments such as clauses.

In some examples, other types of segmentation may be applied to the set of unstructured data. For example, the segmentation model 230 may classify a paragraph as one or more of the following: the start of a segment; the start of another document within the set of unstructured data (e.g. contract document); a signature block; following a page break. Any data blocks which do not fall into these classifications may be combined with an earlier classified data block to for a segment.

At 425, the method classifies each segment into one of a predetermined set of classifications using a trained classification model 240. For simplicity of explanation, only three classified segments 245 are illustrated with respective classifications 247; segment-1 and segment-3 are classified as Class A and segment-2 is classified as Class B. Example classifications where the set of unstructured data is a legal contract document include: Amendment; Breach-Remedy; Injunctive Relief; Confidentiality; Non-disclosure; Data privacy; Conflict of interest; Covenants; Disclaimer; Effective Dates; Enforcement; Force Majeure; Indemnification; Intellectual property ownership; Patents and copyright; Limitation of Liability; and many others.

If it is not possible to classify a clause as one of the predetermined set of classifications, such a segment may be classified as “other”, or similar. The classification model 240 may assign a confidence score to each segment classification and if the score value is below a threshold, such as 70% for example, the segment may not be classified into one of the predetermined set of classifications, but could be classified as “other” or similar.

Classification may be implemented by outputting an embedding vector which can then be compared with the embedding vectors of other segments such as template segments for each classification. A distance between the embedding vectors can be determined and if less than a threshold, the classification of the closest embedding vector may be assigned to the segment. In another implementation, confidence scores may be assigned to a number of classifications, and the classification with the highest score, subject to being above a threshold, being assigned to the segment. Any segments being above a threshold distance from all classification embedding vectors or having all confidence score below a threshold are assigned as “other” or similar.

In an alternative example, classification may be implemented using a classification engine which may classify segments in different ways, for example based on certain words, position within the document, word embedding, probabilistic models, word co-occurrence matrices and/or other natural language processing techniques.

The training of the segmentation model 230 may be implemented using a commercially available pre-trained artificial intelligence neural network and further training this with examples of numerous and different types of paragraphs and corresponding attributes. Similarly, the training of the classification model 240 may be implemented using a commercially available pre-trained artificial intelligence neural network and further training this with examples of numerous and different types of segments or clauses. Known annotation techniques and feedback algorithms may be employed and which are beyond the scope of this document. Some segments may remain unclassified or classified as “other”.

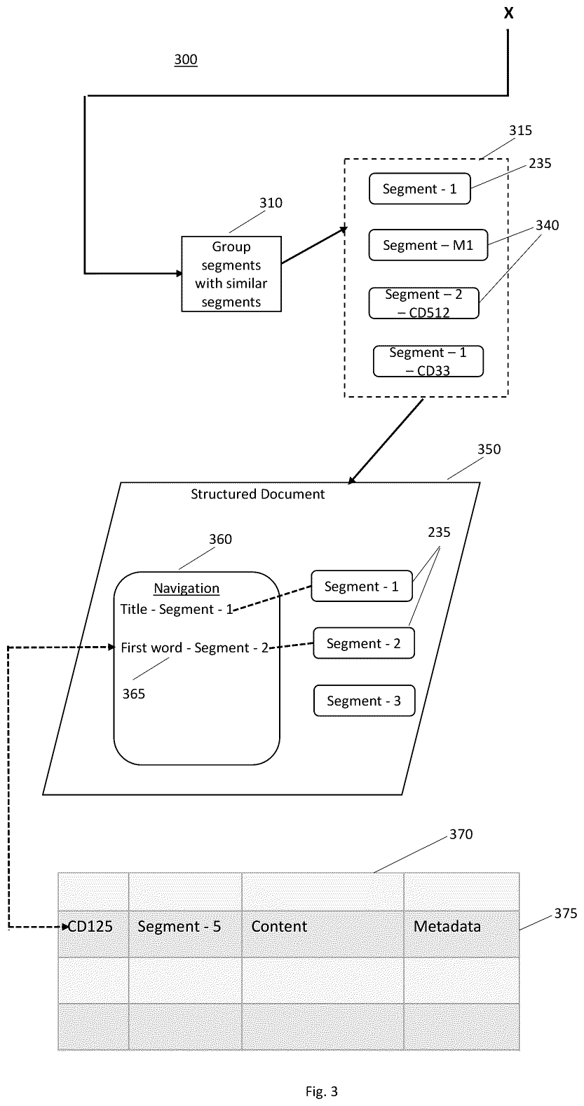

Referring now also to FIG. 3, this is a schematic diagram of a part of the system of FIG. 1 for grouping the segments with similar segments and generating structured data using navigation based on the segmentation, according to an example. The partial system 300 may be used by a user to logically group the segments with similar segments when generating a structured set of data such as a structured contract document. The partial system 300 comprises a group with similar segments engine 310 which may be implemented using rules-based algorithms which may be coded, for example, in C++ and executed using a processor and memory.

At 430, the method logically groups segments with similar segments in a master document or set of segments and/or a library of already structured contract documents. The similarity may be based on meaning or semantics, and/or character differences which may respectively be determined using an embedding distance and/or an edit distance or similar metrics. This may be implemented by storing already structured segments in a datastructure such as a table or database. Classifications may be used to help group similar segments by reducing the number of segments in the datastructure that are compared with each segment under analysis.

An example segment 325, Segment-1, is logically grouped in a group 315 with a number of similar segments 340. These similar segments may be a master segment—Segment—M1—and/or segments from a library of previously structured contract documents (CD)—for example Segment-2 from contract document 512 (Segment—2—CD512) and Segment—1 from contract document 33 (Segment—1—CD33). Whether or not a segment from a master contract document or a master list of segments, or from a library of contract documents or segments is sufficiently similar to be included in the logical group 315, may be based on one or more similarity measures such as a threshold semantic metric (e.g. embedding distance) and/or a threshold character metric (e.g. edit distance) or a percentage of n-words subsets that are similar between two segments.

Classification of segments may be used as a filter to reduce the number of segments to consider, for example by only considering embedding distance or edit distance of segments in the library with the same classification. The number of grouped similar clauses may be based on one or more threshold similarity metrics or a predetermined number of similar segments with the best similarity metrics.

At 435, the method generates a structured set of data or a structured document using the classified and grouped segments. The structured document 350 may be a Word document generated from a template with logical links to the logically grouped segments 315 stored in a database, table or other storage data structure 370 and populates the template to generate the structured document 350 which may then be presented to a user on a user interface or forwarded to another party for comments/review. The datastructure 370 may include a record 375 for each structured segment which includes a label for the segment, a contract document reference, structured content of the segment such as title and key words, as well as metadata such as classifications.

The structured document 350 may include a navigation tool 360 such as a table of contents which includes headings 365 corresponding to each segment. The headings may be a title or a first word of the segment to enable rapid navigation about the document and may also include links to or information about similar segments and metadata such as classifications The navigation tool 360 then enables a user to easily navigate around the structured document 350 in order to find all segments or clauses that may be pertinent to a particular enquiry.

At 440, the method may perform various post-processing functions. Having the segments logically grouped and stored enables various post-processing functions such as comparing the segments of the document with clauses in the same group from a template document to determine a “distance” between a wanted contract document and a current contract document under review. Similarly, easy review and amendment of the contract document by a user is enabled as all relevant clauses for a particular enquiry can be readily found and reviewed. Other post-processing enabled by this arrangement may include: automated risk analysis and scoring (for example based on the distance between a wanted contract document or an approved contract template a current contract document under review); annotation; clustering of similar contract documents and/or segments; normalizing certain data such as date formats; querying the set of structured data for search through the contract library and segment library; summarizing or generating semantic meaning for clauses; key term extraction.

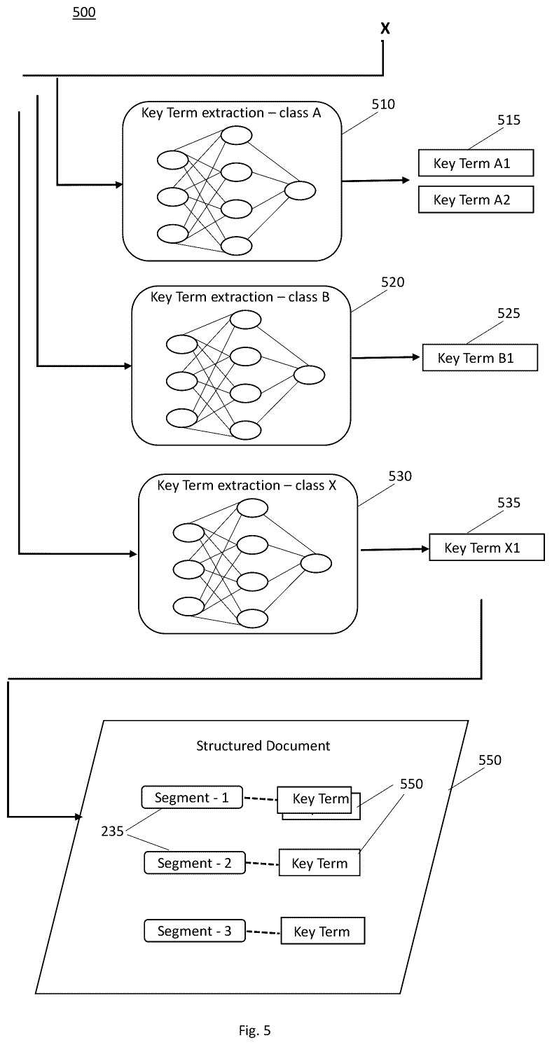

Referring now also to FIG. 5, this is a schematic diagram of a part of the system of FIG. 1 for extracting key terms, according to an example. The partial system 500 may be used by a user to extract key terms from one or more segments which may be used to generate a structured set of data such as a structured contract document. The partial system 500 comprises a plurality of trained machine learning key term extraction models 510, 520, 530, each trained for a respective classification of segment. Each segment classified by a classification model or engine is applied to one or more of these key term extraction models 510, 520, 530 depending on its classification(s). For example, segments classified as class A are applied to Key Term Extraction model 510. Segments having two or more classifications may be applied to two or more corresponding key term extraction models 510, 520. Segments that have not been classified or have been classified in a class which does not have a corresponding key term extraction model are applied to a generic key term extraction model 530.

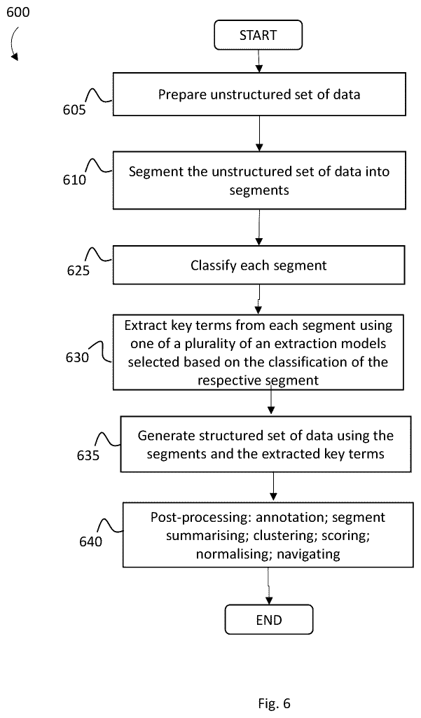

Reference is also made to FIG. 6 which is a flowchart of a method 600 of segmenting and unstructured document, and classifying and extracting key terms from the segments, according to an example. This may be implemented using the partial system 200 of FIG. 2 and the partial system 400 of FIG. 4.

At 605, the method may prepare an unstructured set of data if needed. As previously described with respect to 405, this may involve converting an unstructured document in one format, such as a PDF image, into another format, such as .docx.

At 610, the method segments the unstructured set of data into segments. This may use a data block extraction engine 210, a data block attribute engine 220 and a segmentation model 230 as previously described, however other approaches are possible. For example, character and document formatting and/or natural language processing (NLP) may be used to segment parts of the unstructured document.

At 625, the method classifies each segment. This may be implemented using a classification model 240 as previously described, however other approaches are possible. For example, each clause may be classified using various techniques such as identifying certain words or phrases, word or clause embedding, probabilistic models, word co-occurrence matrices and/or other NLP techniques.

At 630, the method automatically extracts key terms from each segment using one of a plurality of extraction models which are selected based on the classification of the respective segment or clause. Key terms may include dates, periods, amounts and similar quantifiable data related to each type of segment. Examples of contract document key terms include: Party A, Party B, Effective Date, Expiration Date, Contract Term, Indemnification Limit; Payment Terms, Governing Law, and many others. As organizations may have thousands of legacy contract documents, they wish to avoid having to enter key terms manually. This is because manual entry is time-consuming and error prone.

The extraction models 510, 520, 530 may be trained only with certain types of segments, such as a “term” model 510 trained only with term related clauses, and a “indemnification” model 520 which is only trained with indemnification related clauses. By training these models with specific types or classes of segments their accuracy in extracting key terms 515, 525, 535 is improved compared with a single model that is trained with any types of segments. These models 510, 520 are then able to more accurately identify and extract related key terms, such as “termination date” for term clauses and “indemnification amount” for indemnification clauses.

Each key term extraction model 510, 520, 530 may extract respective key terms 515, 525, 535 if these can be identified within an input segment. In some cases, a segment may have more than one classification in which case it may be input to more than one key term extraction model 510, 520 and the extracted key terms 515, 525 collated. Some segments may have a classification for which there is not a specifically trained key term extraction model. In this case a generic or “other” model 530 may be used to attempt to extract key terms 535, and which is trained on a wide range of segment types. For some clauses, key terms may not be extracted.

At 635, the method generates a structured set of data 550 using the segments and extracted key terms. The structured set of data 550 may be stored in a database where each contract document comprises a number of records each having clause text and metadata such as classification and extracted key terms. In an alternative arrangement, the structured set of data 550 may be stored and/or forwarded as a completed textual document such as .docx with metadata indicating the locations of clauses 235 and key terms 550 within the document. Metadata may also indicate the classification of the segments. In this case, the position of extracted key terms may be specified using the word position within the segment or clause and the structured contract document 550.

At 640, the method may perform various post-processing functions, for example as already described with respect to 440. Examples may include: annotation; scoring; summarizing of clauses; normalizing of key terms; clustering; navigating; annual review and amendment via a user interface; forwarding of the structured document to third parties.

A suitable computer implemented algorithm may be used to call the various engines 210, 220, 310 and models 230, 240, 510, 520, 530 to transform an unstructured set of data (e.g. PDF image of a contract document) into a structured set of data (e.g. database records comprising the text and any extracted key terms of the clauses together with any classifications).

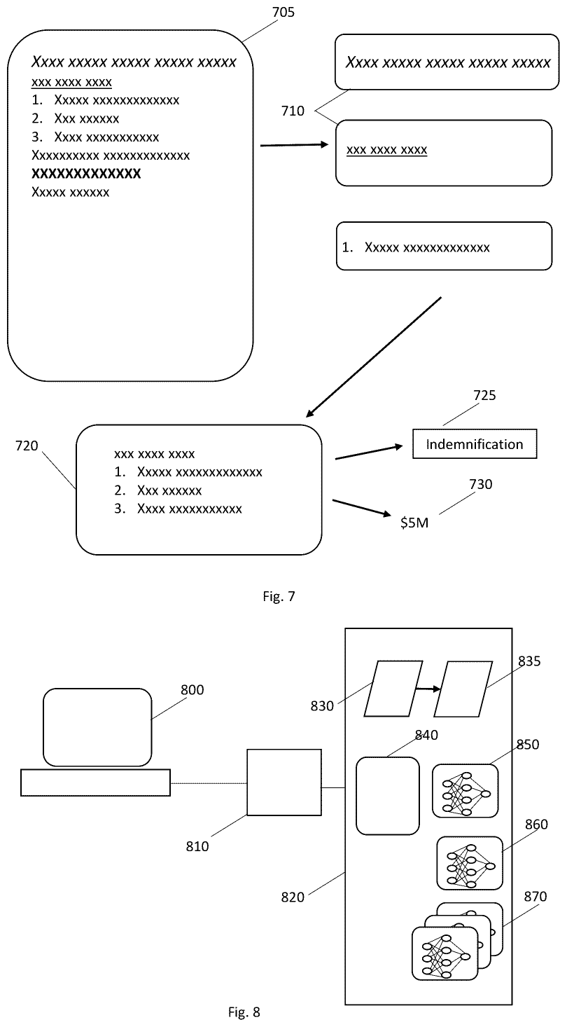

FIG. 7 illustrates in more detail some of the data-structures that may be used, according to an example. An unstructured set of data 705 such as a PDF image of a contract document is illustrated which comprises sequences of characters “x” having different font attributes. These may be grouped into words, lines, paragraphs and so on, with different layout arrangements across the pages of the document. Whilst a person may be able to understand the information encoded in the document, such as process can be time consuming and error prone. Automated processes also suffer from inaccuracy given the very wide range of font, layout and textual arrangements that may be employed by different sources of contract documents.

According to some embodiments the unstructured document 705 may, if necessary be OCR'ed and converted to a common file format such as .docx. The unstructured document may then be transformed into a series of data blocks 710, each of which may comprise sequences of characters having the same the same or similar font attributes, such as having a same size and being in bold and italics “x”, being underlined “x” or not being underlined, in bold and italics “x”.

In one example, these data blocks 710 may correspond to a run or paragraph from a text processing tool such as Aspose.Word. A run is a piece of text having the same font attributes and a paragraph is a combination of sequential runs having the same font attribute and which may be ended by a style separator or paragraph break control character.

A number of language independent attributes for each data block 710 are determined and which may include style attributes associated with individual or groups of characters (e.g. font size, style of previous data block), text attributes associated with the arrangement of the characters within the data block, (e.g. number of words in data block) and segment attributes associated with the arrangement of data blocks within the set of unstructured data (e.g. x position of data block). The data blocks and their respective attributes and then fed into a segmentation model which combines them into segments 720 comprising part of the text of the unstructured set of data 705. Each segment may be associated with a classification 725 and one or more key terms 730.

FIG. 8 illustrates is a schematic diagram of an apparatus for segmenting, classifying, and extracting key terms from a document, according to an example. This may be implemented in a single node or machine, such as a user computer 800 comprising a processor 810 and memory 820. The memory 820 comprises computer readable instructions 840 which when executed by the processor 810, cause the computer to carry out a segmentation, classification, logical grouping and/or key term extraction method such as those illustrated and described with respect to FIGS. 4 and 6. The memory 820 may also comprise a trained segmentation model 850, a trained classification 860, and/or a plurality of trained key term extraction models 870 to help implement these methods. The memory 820 may also store an unstructured set of data 830 such as a PDF image of a third-party prepared contract document and a structured set of data 835 transformed from the unstructured document by the instructions 840 and models 850, 860, 870. The structured contract document 835 may be stored as database records or a file with text and metadata such as a .docx file with bookmarks highlighting the start/end of each segment as well as key terms.

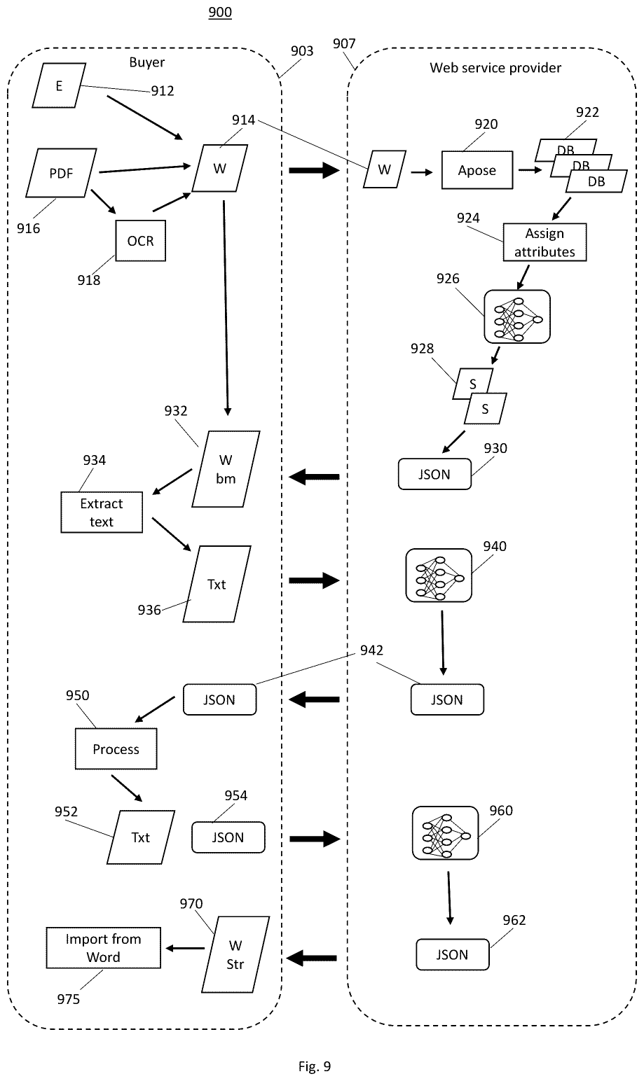

FIG. 9 is a schematic diagram of a distributed system for segmenting, classifying, and extracting key terms from a document, according to an example. In this example, the previously described functionality is distributed between a buyer or user 903 and a web service provider 907. Each of the buyer 903 and webservice provider 907 have associated computer hardware resources including one or more processors and memory/storage to implement their respective functionality. The buyer resources and the service provider resources communicate with each other, for example using the Internet or some secure communications technology in which data may be transferred between them. Distributing functionality in this way is more efficient as it allows for optimization of hardware resources, better exception handling and access to a wider range of contract document examples for further training of segmentation, classification and/or key term extraction models.

At the buyer 903, an unstructured set of data such as an editable contract document file 912 or a PDF image of a contract document 916 is provided. The editable contract document file 912 is converted into a common file format document 914 such as .docx. The PDF image 916 is OCR'ed using an OCR (optical character recognition) process which generates a common file format document 914. The coon file format document 914 is forwarded to the web service provider 907.

The web service provider uses a data block generation tool 920 such as Aspose.Word to generate a series of data blocks 922 as previously described. Each data block is assigned a number of attributes, for example using an attribute assigning engine 924 as previously described. The data blocks and their attributes are feed to a segmentation model 926 as previously described in order to generate a number of segments 928, which may correspond to clauses in a contracts document. The segment prediction results are summarized in a JSON (Java Script Object Notation) file 930 which is forwarded to the byer side 903. This may include the locations of the segments within the common format document file 914.

On the buyer side bookmarks are added to the common format document file 914 to generate a modified document file 932 with bookmarks indicating the segments. The text of each segment 936 is then extracted and forwarded to the web service provider 907 which are then classified using a classification model 940. The classifications for each segment are summarized in another JSON file 942 which is returned to the buyer 903.

The received JSON file is processed by process 950 to concatenate text, the classification result and the client culture such as English-US, English-UK, French-France. This generates modified text 952 for each segment or clause and which are sent with a JSON file summarizing the classification of each segment text 952 to the web service provider side. Each segment text is applied to one or more key term extraction models 960 depending on its classification, as previously described. The extracted key terms for each segment are summarized in another JSON file 962 which is returned to the buyer 903.

The JSON file 962 and segment text 952 are used to generate a structured text document 970 which may be a .docx file with bookmarks indicating the start and end of each segment or clause, bookmarks indicating the location of key terms for each clause, as well as metadata such as the classifications associated with each clause. This structured set of data 970 may then be imported 975 into other post-processing functions to enable further processing such as clustering, annotation, scoring and so on.

By splitting the functionality in this way, separate micro services may be built and available to users who may not need all of the segmentation, classification and key term extraction services. For example, if a user has segmentation functionality, the user can send a paragraph of text to the classification service to find its clause type.

At least some aspects of the embodiments described herein with reference to FIGS. 1-9 comprise computer processes performed in processing systems or processors. However, in some examples, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

In the preceding description, for purposes of explanation, numerous specific details of certain examples are set forth. Reference in the specification to “an example” or similar language means that a particular feature, structure, or characteristic described in connection with the example is included in at least that one example, but not necessarily in other examples.

The above examples are to be understood as illustrative. It is to be understood that any feature described in relation to any one example may be used alone, or in combination with other features described, and may also be used in combination with one or more features of any other of the examples, or any combination of any other of the examples. Furthermore, equivalents and modifications not described above may also be employed.

What is claimed is:

1. A computer-implemented method of transforming an unstructured set of data to a structured set of data; the method comprising:
segmenting the unstructured set of data into clause segments by:
obtaining text from the unstructured set of data, the received text comprising a plurality of characters each having one or more first attributes;
identifying one or more data blocks of text from respective sequences of the characters which share one or more of the one or more first attributes;
determining one or more second attributes for each data block of text, the one or more second attributes comprising attributes additional to the one or more first attributes; and
applying the data blocks of text with respective second attributes to a segmentation model to generate the clause segments, wherein the segmentation model is trained to combine two or more sequential data blocks of text using respective second attributes of the data blocks of text to generate clause segments;
logically grouping the clause segments with similar clause segments;
generating the structured set of data using the grouped clause segments.

2. The method according to claim 1, wherein the one or more second attributes are selected from:
one or more style attributes associated with individual or groups of characters in the respective data block of text;
one or more text attributes associated with the arrangement of the characters within the respective data block of text;
one or more paragraph attributes associated with the arrangement of the respective data block of text within the set of unstructured data;
a classification of the respective data block of text.

3. The method according to claim 2, wherein identifying the one or more data blocks of text comprises:
identifying sequences of characters in the unstructured set of data having a common characteristic;
combining one or more sequences of characters according to predetermined logic to identify each said data block.

4. The method according to claim 1, wherein the similar clause segments are determined from a library of structured sets of data and based on an at least one of edit distance and an embedding distance between the clause segment and a legal-clause segment in the library.

5. The method of claim 1, comprising classifying each clause segment into one of a predetermined set of classifications.

6. The method according to claim 5, wherein classifying each clause segment comprises applying each clause segment to a classification model.

7. The method according to claim 5, extracting key terms from each clause segment using an extraction model, the extraction model selected from a plurality of extraction models based on the classification of the clause segment.

8. The method according to claim 4, wherein a said clause segment is applied to a plurality of extraction models corresponding to respective key terms based on the classification of the clause segment.

9. The method of claim 8, wherein the classification model outputs a confidence score for the classification; and wherein the extraction model selected from the plurality of extraction models is dependent on the classification and the confidence score.

10-18. (canceled)

19. A system for transforming an unstructured set of data to a structured set of data, the system having a processor and memory comprising processor readable instructions which when executed on the processor, cause the processor to:
segment the unstructured set of data into clause segments by:
obtaining text from the unstructured set of data, the received text comprising a plurality of characters each having one or more first attributes;
identifying one or more data blocks of text from respective sequences of the characters which share one or more of the one or more first attributes;
determining one or more second attributes for each data block of text, the one or more second attributes comprising attributes additional to the one or more first attributes; and
applying the data blocks of text with respective second attributes to a segmentation model to generate the clause segments, wherein the segmentation model is trained to combine two or more sequential data blocks of text using respective second attributes of the data blocks of text to generate clause segments;
logically group the clause segments with similar clause segments;
generate the structured set of data using the grouped clause segments.

20. (canceled)

21. The system of claim 19, wherein the memory comprises processor readable instructions that include:
a data block extraction engine to identify the data blocks; and
a data block attribute engine to determine the plurality of segmentation attribute.

22. A non-transitory computer-readable medium storing a program for transforming an unstructured set of data to a structured set of data, the computer readable medium comprising instructions, that when executed by at least one processor, cause the at least one processor to:
segment the unstructured set of data into legal clause segments by:
obtaining text from the unstructured set of data, the received text comprising plurality of characters each having one or more first attributes;
identifying one or more data blocks of text from respective sequences of the characters which share one or more of the one or more first attributes;
determining one or more second attributes for each data block of text, the one or more second attributes comprising attributes additional to the one or more first attributes;
applying the data blocks of text with respective second attributes to a segmentation model to generate the clause segments, wherein the segmentation model is trained to combine two or more sequential data blocks of text using respective second attributes of the data blocks of text to generate clause segments;
logically group the clause segments with similar clause segments;
generate the structured set of data using the classified and grouped clause segments.
